(19) United States
(12) Patent Application Publication
(10) Pub. No.: US 2007/0165850 A1
(43) Pub. Date: Jul. 19, 2007

(54) Embedding of signal dependent properties in a media signal

(75) Inventors: Minne Van Der Veen, Eindhoven (NL); Aweke Negash Lemma, Eindhoven (NL); Rene Barto, Eindhoven (NL); Adriaan Johan Van Leest, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,331

(22) PCT Filed: Dec. 1, 2004
(86) PCT No.: PCT/IB04/52627

§ 371 Date: Jun. 9, 2006

(30) Foreign Application Priority Data
Dec. 11, 2003 (EP) 03104645.1

(51) Int. Cl. H04N 7/167

(52) U.S. Cl. 380/201

(57) ABSTRACT

The present invention relates to a method and device for simplifying distribution of a processed media signal and a method and device for distributing a media signal. A properties determining unit (12, 14) determines a set of signal dependent properties (w,a) of a media signal (x). An embedding unit (16) embeds the signal dependent properties in the media signal in order to provide a modified media signal (x′). An extracting unit (22) retrieves the modified media signal (x′) from a media signal storage (18) and extracts the signal dependent properties (w, a). A signal processing unit (24, 26) then processes the media signal using the signal dependent properties, such that the processed media signal can be provided for distribution to at least one recipient. In this way storage space is saved and the complexity of an electronic content delivery system is reduced.

The present invention generally relates to the field of distributing media signals and more particularly to a method, device, signal, system, and computer program product for simplifying distribution of a processed media signal and a method and device for distributing a media signal.

It is widely known to watermark media signals in order to prevent illegal copying and distribution of the media signals, and/or trace illegally distributed content. In this way a rightful owner of a media signal can detect if for instance copies of a media signal have been illegally made. A media signal is often a video or an audio signal, but it should be realized that media signals are in no way limited to these two types of signals.

With the introduction of Internet, there has been a revolution within the field of distribution of media content, through allowing downloading of media signals from Electronic Content Delivery Systems. A content provider can then have a database of different media signals and deliver copies of these to different users via the Internet. The content is then often compressed according to some compression scheme, like AAC audio or MPEG-2 video. A purchaser of this content then often expects an instantaneous or direct delivery of or access to the content. In order to safeguard illegal copying of these media signals it is then necessary to watermark each copy distributed with a possibly unique watermark.

Watermarking can however in many cases be relatively time consuming and involve complex computing operations, which means that if watermarking is performed just before delivery of a media signal there can be considerable delays in the delivery.

One way of reducing this delivery delay is to immediately watermark and compress a signal at the time of creation. W01/06703 describes delivery of audio content where a signal is watermarked at the time of creation and then compressed before delivery to a network distributor, from where it is being distributed to different clients.

However, it is furthermore often desirable to watermark the delivered signal as late as possible in order to include such information as the identity of the client who orders the media signal, which cannot be done until the client has been identified by him/her placing an order for the content. This information in the watermark can then be used for forensic tracking of the content. It is furthermore often desirable to perform the compression after the watermarking, in which case this also has to be made as late as possible. Also this compression of the media signal can be time consuming. The quality of the signal delivered can often also be selected by the client, in which case it would also be advantageous to provide the compression into a deliverable format as late as possible. This means that if a content provider is to deliver many copies of a media signal at the same time to different clients, the watermarking and compression process for each copy of the media signal will take a long time if these processes are performed late, which can lead to many clients receiving their ordered media signal after a considerable delay, which is in many cases not acceptable.

However, if pre-calculations relating to the compression and/or watermarking are made beforehand, the watermarking and/or compression performed at the time of receipt of an order for media content is speeded up considerably. The results of these pre-computations in relation to a media signal then have to be stored, which requires additional memory space. There would also be required a fairly complex database management system to keep track of which results of different pre-calculations belong to what media signals.

There is therefore a need for providing watermarking and/or compression of a media signal that is faster, while at the same time keeping the storage space for the additional data as low as possible and enabling a simpler system for locating the additional content.

It is thus an object of the present invention to provide faster watermarking and/or compression of a media signal at the time of delivery while keeping the additional storage space needed for additional data resulting from pre-calculations as low as possible, and possibly avoiding complex database management protocols.

According to a first aspect of the present invention, this object is achieved by a method of simplifying distribution of a processed media signal comprising the steps of:
(a) determining at least one set of signal dependent properties of a media signal
(b) embedding signal dependent properties in the media signal, and
(c) storing the thus modified media signal, such that the signal dependent properties can be extracted and used for processing the media signal when the media signal is to be distributed.

According to a second aspect of the present invention, this object is also achieved by a method of distributing a processed media signal comprising the steps of:
(d) retrieving a modified media signal, which has been obtained by embedding at least one set of signal dependent properties related to the media signal in the media signal,
(e) extracting at least one set of signal dependent properties from the modified media signal,
(f) processing said media signal using said set of signal dependent properties, and
(g) providing the thus processed media signal for at least one recipient

According to a third aspect of the present invention, this object is furthermore achieved by a device for simplifying distribution of a processed media signal comprising:

at least one properties determining unit for determining a set of signal dependent properties of a media signal,

an embedding unit for embedding signal dependent properties in the media signal in order to provide a modified media signal, and

a storing unit for storing the thus modified media signal, such that the signal dependent properties can be extracted from the modified media signal for later use in processing the media signal when the media signal is to be distributed.

According to a fourth aspect of the present invention, this object is furthermore achieved by a device for distributing a media signal comprising:

an extracting unit arranged to retrieve a modified media signal from a media signal storage, which modified media signal has been obtained by embedding at least one set of signal dependent properties related to the media signal in said media signal, and extract at least said one set of signal dependent properties,

at least one signal processing unit arranged to process said media signal using said set of signal dependent properties, and

means for providing the processed media signal for at least one recipient.

The object according to the present invention is further achieved by a signal according to claim 28, a system according to claim 29, and a computer program product according to claim 30.

By embedding a set of signal dependent properties in the media signal considerable storage space is saved compared to if these properties were to be stored separately. There is furthermore a reduced risk of exchanging properties associated with one media signal for properties associated with another media signal, which can be the case if the properties are stored separately. This also simplifies the management and architecture of storing a media signal with associated signal dependent properties, which is an advantage if the media signal is to be distributed from different physical locations.

Claims 2 and 14 are directed towards signal compression according to a first compression scheme and providing signal dependent properties for this signal compression, which allows faster compression at the time of delivery and also makes it possible to provide varied compression levels for different output signals.

Claims 3 and 15 are directed towards providing an alternative set of signal dependent properties associated with a second compression scheme, which allows, in addition to faster compression and variable compression levels, also the selection of different types of compression of the media signal.

Claims 5, 17 and 24 are directed towards watermarking the media signal and providing signal dependent properties for this watermarking, which allows faster watermarking at the time of delivery. This watermarking is additionally well suited for forensic tracking.

Claims 6, 10, 18 and 21 are directed towards embedding using a reversible watermarking technique, which essentially restores the original media signal. In this way transcoding and potential introduction of artefacts are avoided.

Claims 8, 19 and 22 are directed towards using a buried data channel technique, which introduces a channel for the signal dependent properties that has a higher capacity.

The general idea behind the invention is thus to provide signal dependent properties embedded in said media signal that speeds up processing of the media signal. In this way storage space is saved.

These and other aspects of the invention will be apparent from, and elucidated with reference to the embodiments described hereinafter.

The present invention will now be explained in more detail in relation to the enclosed drawings, by way of example, where

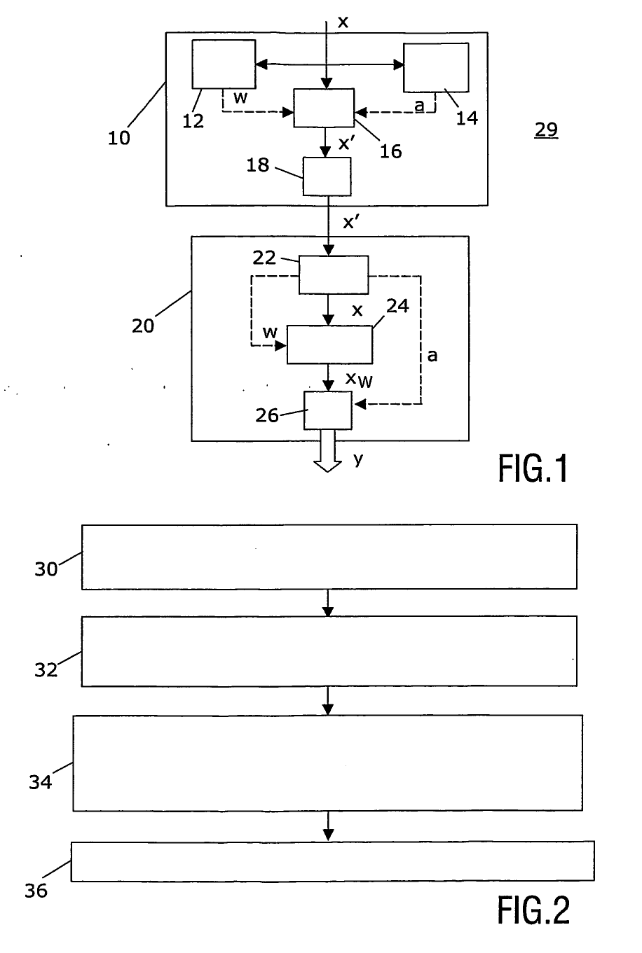

FIG. 1 shows a block schematic of a first device for simplifying distribution of media signals and a second device for distributing media signals according to a first embodiment of the invention,

FIG. 2 shows a flow chart of a method of simplifying distribution of media signals that the first device in FIG. 1 is working according to,

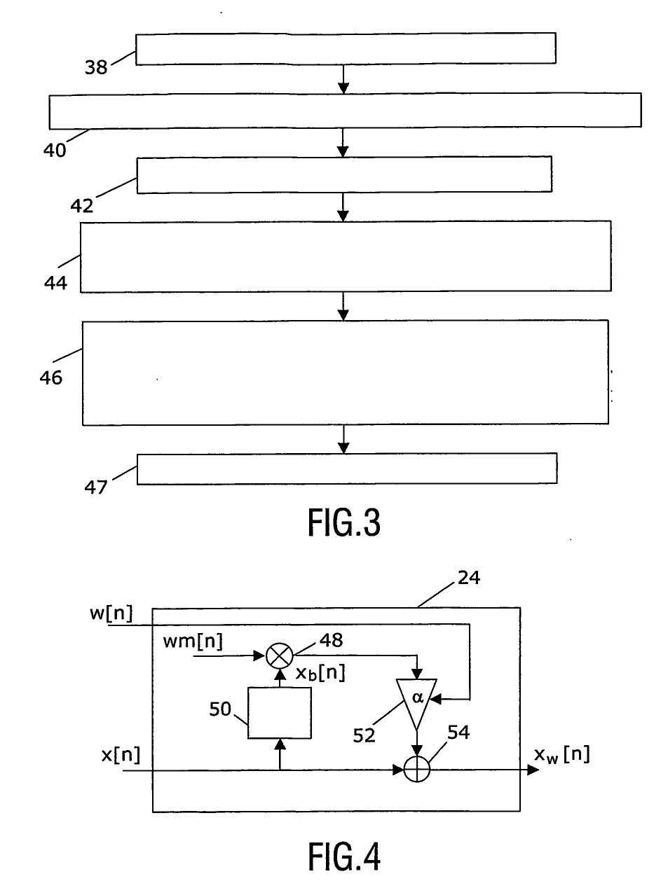

FIG. 3 shows a flow chart of a method of distribution media signals that the second device in FIG. 1 is working according to,

FIG. 4 shows a block schematic of a watermarking unit that can be used in the second device in FIG. 1,

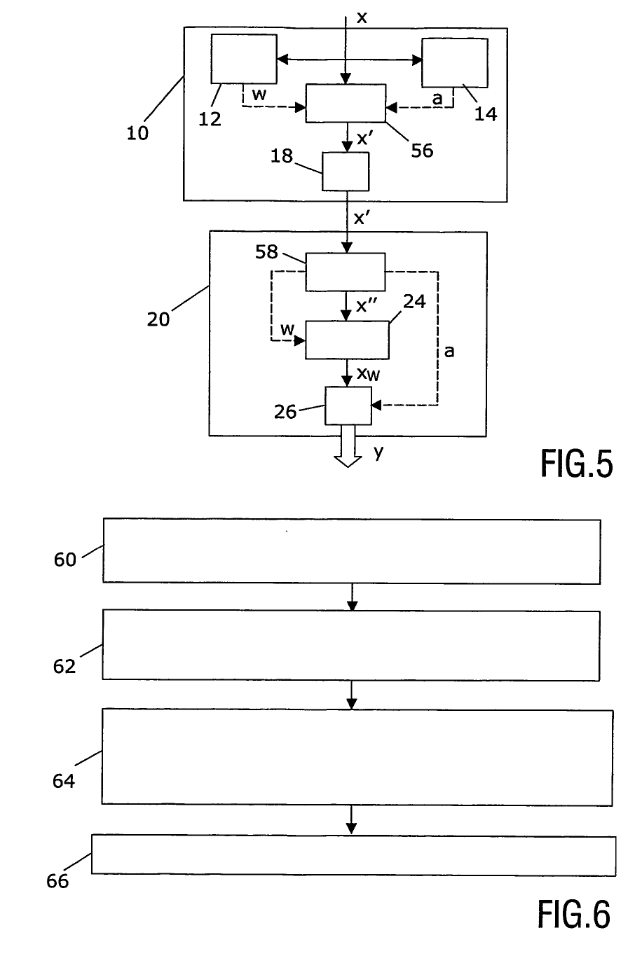

FIG. 5 shows a block schematic of an alternative first device for simplifying distribution of media signals and an alternative second device for distributing media signals according to a second embodiment of the invention,

FIG. 6 shows a flow chart of a method of simplifying distribution of media signals that the first alternative device in FIG. 5 is working according to,

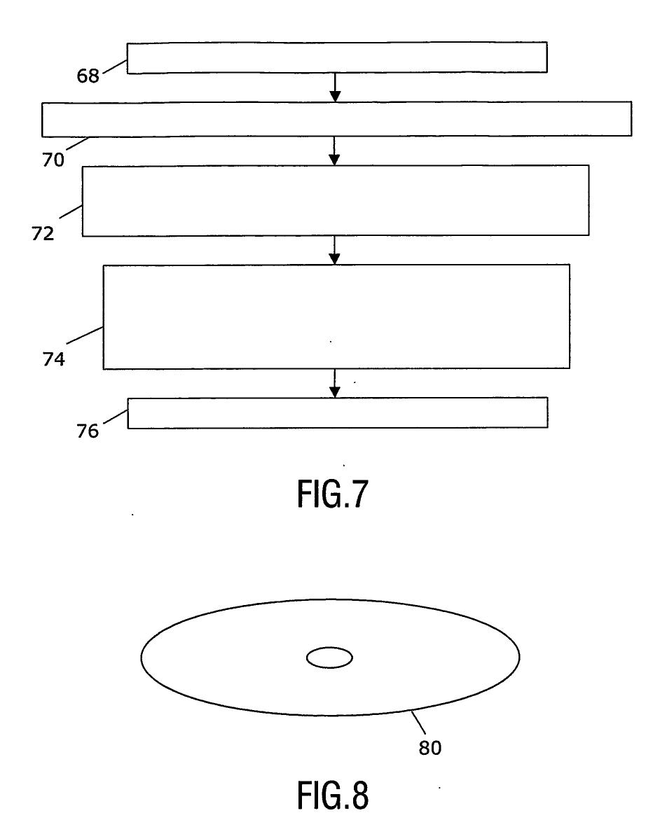

FIG. 7 shows a flow chart of a method of distribution media signals that the second alternative device in FIG. 5 is working according to, and

FIG. 8 shows a computer program product.

The present invention relates to the field of providing watermarks in and compression of media signals and is especially arranged for provision of watermarks in electronic media signal delivery systems.

According to a first embodiment of the invention, FIG. 1 shows a block schematic of such an electronic media delivery system comprising a first device 10 for simplifying distribution of a processed media signal, which is connected to a second device 20 for distributing the processed media signal. The present invention is based on the understanding that different types of processing operations relating to media signals, like watermarking and compression, can be divided into different parts, where some operations can be provided or performed beforehand and others can be performed when the processing is needed to be performed. The purpose of the devices in FIG. 1 is therefore, in the preferred embodiment of the invention, to deliver a media signal y when a user requests such a signal, which media signal is compressed and watermarked. However the actual compression and watermarking are not finalized until a request for delivery is received. If the watermarking and compression of the media signal is all made at the time of receipt of an order there will however be considerable delays in the delivery, which a client will normally not accept. According to the present invention there are therefore performed pre-calculations before the request is received, which pre-calculations are then used in the finalizing of the watermarking and compression performed at the time of delivery of the media signal.

The functioning of the first device 10 will now also be described in relation to FIG. 2, which shows a flow chart of the method the device is working according to. The method according to the invention thus starts with a raw unprocessed or uncompressed media signal x, which in the preferred embodiment is an audio signal having the PCM format (Pulse Code Modulation). The media signal x is thus an audio signal, but it should be realized that the invention is in no way limited to these types of signals. It can for instance. also be applied to video signals. The working of the first device 10 is performed off-line or before a request for delivery is received. The unprocessed media signal x is therefore provided to a first properties determining unit in the form of a watermark pre-calculating unit (WPC) 12, to a second properties determining unit in the form of a compression pre-calculating unit (CPC) 14 and to an embedding unit in the form of a reversible watermarking unit (RW) 16. The watermark pre-calculating unit 12 determines a first set of watermarking properties w that are based on the media signal x to be watermarked, step 30. The compression precalculating unit 14 determines a second set of compression properties a of the unprocessed media signal x to be used in the compression of the media signal, step 32. Both these sets of properties w and a are then provided to the reversible watermarking unit 16, which embeds these properties in the unprocessed media signal using reversible watermark encoding in order to obtain a modified media signal x′, step 34. The reversible watermarking unit 16 then stores the modified media signal x′ in a media signal storage or database DB 18, step 36.

By embedding the different sets of properties in the media signal considerable storage space is saved compared to if these properties were to be stored separately. There is furthermore a reduced risk of exchanging properties associated with one media signal for properties associated with another media signal, which can be the case if the properties are stored separately. This also simplifies the management and architecture of the database in that it is possible to avoid complex database management protocols, which is an advantage if the media signal is to be distributed from different physical locations. The media signal is furthermore playable, which means that the correctness of the signal can easily be checked when it is to be delivered.

How the devices according to FIG. 1 are working when a request for a media signal is received will now be explained with reference being made to FIGS. 1 and 3, which latter Figure shows a flow chart of the method the second device is working according to. In this part of the invention, the device 20 is thus working on-line. When the second device 20 receives a request for a certain media content, the second device 20 retrieves the modified media signal x′ from the database 18 of the first device 10, step 38, where the modified media signal is forwarded to an extracting unit in the form of a reversible watermarking decoding unit (RWD) 22. The reversible watermarking decoding unit 22 then extracts both the sets of properties w and a from the modified media signal, step 40. The reversible watermarking decoding unit 22 then supplies the first set of signal dependent properties w to a first processing unit in the form of a watermark embedding unit (WE) 24 and the second set of signal dependent properties a to a second processing unit in the form of a signal compression unit (C) 26. The reversible watermarking decoding unit 22 also restores the unprocessed media signal x, step 42. Thereafter the watermark embedding unit 24 embeds a unique watermark in the restored media signal x using the signal dependent properties w, step 44, and supplies the thus watermarked signal x_{w} to the signal compression unit 26, which compresses the watermarked signal x_{w} using the second set of signal dependent properties a for providing the output signal y, step 46. The signal compression unit 26 thereafter delivers the watermarked and compressed output signal y to the client, step 47.

According to the above-mentioned method it is possible to quickly deliver a media signal to a client. Naturally the same signal can be delivered to several different clients, each having a different unique watermark. However, the watermarks have then all been generated using the same set of signal dependent properties. When performing the compression in the above-described way it is possible to provide varied compression levels for different output signals, while still enabling the provision of a fast compression. The output quality can be selected by simply selecting an appropriate bit rate. Since the processing in the second device is performed on a “raw” PCM signal, transcoding and potential introduction of artefacts are avoided.

The reversible watermarking unit and the reversible watermarking decoding unit can be based on inserting the additional data, i.e. the sets of properties onto remapped amplitude values of the unprocessed media signal. According to this technique the output signal from the embedding has the same format as the input signal for the embedding, and the original signal can be reconstructed in an at least close to bit-exact manner. One such technique is described in more detail in European Patent Application No. 03100093.8, which is herein incorporated by reference. This document also describes how a reversible watermarking decoding unit would work. This technique provides a data channel having a capacity of about 1 bit per sample of the unprocessed media signal, which corresponds to a bit rate of about 44 kbit/s, which is enough for allowing the insertion of at least two sets of signal dependent properties.

The second set of signal dependent properties that are determined beforehand are such things as psycho-acoustic properties, such as masking threshold parameters for use in the different subbands of the compressed signal to be delivered. These calculations are relatively time consuming but as they are based on the properties of the signal, they can be made beforehand. When the compression unit then compresses the media signal it can work faster because the properties have been determined beforehand. In the preferred embodiment the compression scheme used is AAC, although the invention is not limited to this scheme. The scheme can for instance alternatively be MP3. AAC provides bit rates of approximately 13 kb/s for this second set of signal dependent properties. Other possible properties than masking threshold parameters that can be used for the compression can be quantization levels and scale factors.

The first set of signal dependent properties that are determined beforehand are such things as psycho-acoustic properties such as masking threshold parameters for use in the watermarking process. These calculations are relatively time consuming but as they are also based on the properties of the signal, they can be made beforehand. When the watermark embedding unit then watermarks the media signal it can work faster because the properties have been determined beforehand. More details of one watermarking scheme will be given later, for which example bit rates of approximately 7 kb/s are provided.

Given the above mentioned bit rates of the different sets of signal dependent properties it can thus be seen that the reversible watermarking channel capacity is large enough to include both these sets of signal dependent properties.

How an actual watermark embedding unit can be made to work will now be described with reference being made to FIG. 4, which shows a block schematic of an envelope modulation watermark embedding unit 24. The device is a device for watermarking of signal samples, like for instance of audio signal samples like PCM samples. This is however just one example of the type of signals in which watermarking according to the invention can be performed. The watermark embedding unit 24 includes a bandpass filter 50, which filters the media signal x[n] and provides the filtered signal x_{b}[n] to a multiplying unit 48, which also receives a watermark wm[n] and multiplies the watermark wm[n] with the filtered media signal x_{b}[n]. The output of the multiplying unit 48 is connected to a scaling unit 52, which scales the output signal from the multiplying unit 48 with a scaling parameter α and provides it to an adding unit 54, which also receives the media signal x[n]. The output of the adding unit 54 is then the watermarked media signal x[n]. The scaling factor α is controlled by a signal w[n], which signal is made up of the first set of signal dependent properties. These properties are in this example decided based on a psycho-acoustic model of the human hearing system in order to ensure that the watermark is not perceptible to a user or client or provided beneath a masking threshold of the signal x[n]. These properties, which are highly dependent on the media signal x, are therefore calculated beforehand. The calculation of these properties is quite complex and time demanding, but is however only needed to be made once for each signal. Also the bandpass filtered signal x_{b}[n] is fixed in the sense that it is not influenced by the watermark and can just as well be calculated beforehand. This will make the watermark embedding unit simpler in structure. It should be realized that the watermarking properties dependent on the media signal are not limited to being based on a psycho-acoustic model of the human hearing system. In case the media signal is a video signal an appropriate psycho-visual model of the human visual system is used. The model is therefore a model of a human sensing system. More detail about the specific watermarking technique shown in FIG. 4 can be found in the document, “A temporal domain audio watermarking technique”, by Aweke Negash Lemma, Javier Aprea, Wemer Oomen and Leon van de Kerkhof, IEEE Transactions on Signal Processing, April 2003, Vol. 51, page 1088-1097, which is herein incorporated by reference.

FIGS. 5, 6 and 7 are directed towards a second embodiment of the present invention. The devices in FIG. 5 are generally the same as the devices in FIG. 1, therefore only the differences will be described here. Instead of a reversible watermarking unit (RW), the first device 10 includes a buried data channel providing unit (BDCP) 56 and instead of a reversible watermarking decoding unit (RWD) the second device 20 includes a buried data channel extracting unit (BDCE) 58. With reference now being made to FIG. 6, the watermark pre-calculating unit 12 as before determines a first set of watermarking properties w that are based on the media signal x to be watermarked, step 60. The compression pre-calculating unit 14 determines a second set of compression properties a of the unprocessed media signal x to be used in the compression of the media signal, step 62. Both these sets of properties w and a are then provided to the buried data channel providing unit 56, which creates a buried data channel in the media signal and inserts these properties in the channel in order to obtain a modified media signal x′, step 64. The buried data channel providing unit 56 then stores the modified media signal x′ in the database 18, step 66. Reference is now being made also to FIG. 7. When the second device 20 receives a request for a certain media content corresponding to the media signal x′, the second device 20 retrieves the modified media signal x′ from the data base 18 of the first device 10, step 68, where the modified media signal is forwarded to an extracting unit in the form of the buried data channel extracting unit 58. The buried data channel extracting unit 58 then extracts both the sets of properties w and a from the modified media signal x′, step 70. The buried data channel extracting unit 58 then supplies the first set of signal dependent properties w to the watermark embedding unit 24 and the second set of signal dependent properties a to the compression unit 26. However, in this embodiment the original signal is not restored, but instead some distortion is normally introduced. This distortion is normally not perceptible. The slightly distorted media signal x″ is then supplied to the watermark embedding unit 24, which embeds a unique watermark in the media signal x″ using the signal dependent properties w, step 72, and supplies the thus watermarked signal x_{w} to the compression unit 26, which compresses the watermarked signal using the second set of signal dependent properties a, step 74. The compression unit 26 thereafter delivers the watermarked and compressed output signal y to the client, step 76.

Since the signal is not restored there might be some permanent distortions introduced. These distortions might however not be relevant depending on the quality of the signal that is to be delivered. More details about the use of a buried data channel can be found in “A variable bitrate buried-data channel for compact disc”, by Oomen, A. W. J, Groenewegen, M. E, van der Waal, R. G. and Veldhuis, R. N. J., Journal of the Audio Engineering Society, Vol. 43, No 1/2, pp. 23-28, 1995, which is herein incorporated by reference.

This second embodiment thus introduces some distortion, but on the other hand a channel having a higher capacity is introduced, which means that more signal dependent properties can be embedded in the media signal.

There are a number of modifications that can be made to the present invention that was outlined above. There can be several second devices connected to one first device, so that media content can be ordered from several different contact points. The first device need furthermore not include the database, but this can be provided as a separate entity. The database can furthermore be provided in the second device instead. It is furthermore possible to provide more than one pair of compression/watermark embedding units together that can provide different uniquely watermarked media signals for different clients. The invention can furthermore be provided with only watermarking or only compression, in which case only one set of signal dependent properties might be embedded in the media signal. Moreover, the invention is in no way limited to reversible watermarking or using a buried data channel for embedding of signal dependent properties in the media signal, but any suitable encoding technique can be used for this embedding.

Another possible variation of the present invention is to embed also a third set of signal dependent properties, which are for instance directed towards providing help for compression according to another compression scheme. If the second set were directed towards AAC, this third set could then be directed towards MP3. Then a client might get to select which compression scheme is to be used and the second device would select a compression unit according to the selected scheme and use the set of signal dependent properties of that scheme to speed up the compression of the media signal.

As mentioned above, the invention is not limited to audio signals, but can be applied also on other types of media signals, like video signals. In the case of video signals the signal dependent properties can include such things as run-codes.

The present invention has many advantages apart from the ones already described. The watermark embedding according to the invention is particularly well suited for forensic tracking, where watermarks are embedded in files distributed via an Electronic Content Delivery System, and used to track for instance illegal copied content on the Internet.

FIG. 8 shows a computer program product on a carrier (80).

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. A single processor or other (programmable) unit may also fulfill the functions of several means recited in the claims.

In the device claim enumerating several means, several of these means can be embodied by one and the same item of hardware. The mere fact that certain measures are recited in mutually different dependent claims does not indicate that a combination of these measures cannot be used to advantage.

1. Method of simplifying distribution of a processed media signal comprising the steps of:
(a) determining at least one set of signal dependent properties of a media signal (x),
(b) embedding signal dependent properties in the media signal, and
(c) storing the thus modified media signal (x′), such that the signal dependent properties can be extracted and used for processing the media signal when the media signal is to be distributed.

2. Method according to claim 1, wherein one set of signal dependent properties (a) is to be used for simplifying the compression of the media signal according to a first compression scheme.

3. Method according to claim 2, wherein the step of determining comprises determining another set of signal dependent properties of the media signal that can be used for simplifying the compression of the media signal according to a second compression scheme and the step of embedding comprises embedding said other set of signal dependent properties in the media signal.

4. Method according to claim 1, wherein one set of signal dependent properties is chosen from a group comprising: perceptual properties, masking thresholds, quantization levels, scale factors and run-levels.

5. Method according to claim 1, wherein one set of signal dependent properties (w) is to be used for simplifying watermarking the media signal.

6. Method according to claim 1, in which the step of embedding the set of signal dependent properties is done using a reversible watermarking technique, where the output signal from the embedding (x′) has the same format as the input signal (x) for the embedding, and where the original signal (x) can be reconstructed in an at least close to bit-exact manner.

7. Method according to claim 1, wherein the embedding is non-reversible.

8. Method according to claim 7, wherein the embedding is done in a buried data channel.

9. Method according to claim 1, further comprising the steps of:
(d) retrieving the modified media signal,
(e) extracting at least one set of signal dependent properties from the modified media signal,
(f) processing said media signal using said set of signal dependent properties, and
(g) providing the thus processed media signal for at least one recipient.

10. Method according to claim 9, wherein, the original media signal is restored in an at least close to bit-exact manner before processing.

11. Method according to claim 9, wherein the steps of determining, embedding and storing are performed before a request for delivery of the media signal is received and the steps of retrieving, extracting, processing and providing are performed at the time of receiving a request for delivery of the media signal.

12. Method of distributing a processed media signal comprising the steps of:
(d) retrieving a modified media signal (x′), which has been obtained by embedding at least one set of signal dependent properties related to the media signal in the media signal (x),
(e) extracting at least one set of signal dependent properties from the modified media signal,
(f) processing said media signal using said set of signal dependent properties, and
(g) providing the thus processed media signal for at least one recipient.

13. Device (10) for simplifying distribution of a processed media signal comprising:
at least one properties determining unit (12 or 14) for determining a set of signal dependent properties (a or w) of a media signal (x),
an embedding unit (16 or 56) for embedding signal dependent properties in the media signal in order to provide a modified media signal (x′), and
a storing unit (18) for storing the thus modified media signal (x′), such that the signal dependent properties can be extracted from the modified media signal for later use in processing the media signal when the media signal is to be distributed.

14. Device according to claim 13, wherein one properties determining unit (14) is arranged to determine a set of signal dependent properties (a) to be used for simplifying the compression of the media signal according to a first compression scheme.

15. Device according to claim 14, wherein one properties determining unit is arranged to determine another set of signal dependent properties of the media signal that can be used for simplifying the compression of the media signal according to a second compression scheme and the embedding unit (24) is arranged to embed also these other signal dependent properties in the media signal.

16. Device according to claim 13, wherein one set of signal dependent properties is chosen from a group comprising: perceptual properties, masking thresholds, quantization levels, scale factors and run-levels.

17. Device according to claim 13, wherein one properties determining unit (12) is arranged to determine a set of signal dependent properties (w) to be used for simplifying watermarking the media signal.

18. Device according to claim 13, wherein the embedding unit comprises a reversible watermarking unit (16) where the output signal from the embedding (x′) has the same format as the input signal (x) before the embedding, and where the original signal (x) can be reconstructed in an at least close to bit-exact manner.

19. Device according to claim 13, wherein the embedding unit comprises a buried data channel providing unit (56).

20. Device according to claim 13, further comprising:
an extracting unit (22,58) arranged to retrieve the modified media signal (x′) from the media signal storage and extract at least one set of signal dependent properties,
at least one signal processing unit (24,26) arranged to process said media signal using said set of signal dependent properties, and
means for providing the processed media signal for at least one recipient.

21. Device according to claim 20, wherein the extracting unit comprises a reversible watermarking decoding unit (22).

22. Device according to claim 20, wherein the extracting unit comprises a buried data channel extracting unit (58).

23. Device according to claim 20, wherein one signal processing unit is a watermark embedding unit (24).

24. Device according to claim 20, wherein one signal processing unit is a signal compression unit (26).

25. Device according to claim 20, wherein the properties determining unit and embedding unit are set to work before a request for delivery of the media signal is received and the extracting unit and signal processing unit are set to work not before receiving a request for delivery of the media signal.

26. Device (20) for distributing a media signal comprising:
an extracting unit arranged to retrieve a modified media signal (x′) from a media signal storage (18), which modified media signal has been obtained by embedding at least one set of signal dependent properties related to the media signal in said media signal, and extract at least said one set of signal dependent properties,
at least one signal processing unit (24,26) arranged to process said media signal using said set of signal dependent properties, and
means for providing the processed media signal for at least one recipient.

27. Device according to claim 26, further comprising a media signal storage of the modified media signal (x′).

28. Signal carrying modified media signal (x′) as generated by claim 1.

29. System (29) for distributing a media signal comprising the devices of claim 13.

30. Computer program product (80) capable to implement any of the methods of claim 1.
